(19) United States
(12) Patent Application Publication
(10) Pub. No.: US 2009/0247345 A1
(43) Pub. Date: Oct. 1, 2009

(54) Drive For A Working Machine, In Particular A Press Drive, And A Working Machine, In Particular A Forming Press

(75) Inventors: Alexander P. Desch, Arnsberg (DE); Bernhard Plattfaut, Hamm (DE); Uwe Geilker, Arnsberg (DE)

Correspondence Address: LERNER GREENBERG STEMER LLP, P O BOX 2480, HOLLYWOOD, FL, 33022-2480, US

(73) Assignee: DESCH ANTRIEBSTECHNIK GMBH & CO. KG, Arnsberg (DE)

(21) Appl. No.: 12/411,661

(22) Filed: Mar. 26, 2009

(30) Foreign Application Priority Data
Mar. 26, 2008 (DE) 10 2008 015 882.8

(51) Int. Cl. F16H 57/10; F16H 57/00; F16D 65/14

(52) U.S. Cl. 475/149; 74/411.5; 188/166

(57) ABSTRACT

A drive for a working machine, in particular a press drive, includes an electric motor, a transmission, and a brake. The brake is disposed between the transmission and the electric motor. A forming device, such as a forming press, includes a press housing, a press shaft, and a drive for the press shaft. The drive is configured as outline above.

### CROSS-REFERENCE TO RELATED APPLICATION

This application claims the priority, under 35 U.S.C. § 119, of German patent application DE 10 2008 015 882.8, filed Mar. 26, 2008; the prior application is herewith incorporated by reference in its entirety.

### BACKGROUND OF THE INVENTION

### Field of the Invention

The present invention relates to a drive for a working machine, in particular a press drive. Furthermore, the invention pertains to a working machine, in particular a forming press, comprising a press housing, a press shaft, and a drive for the press shaft.

A drive according to the state of the art for a working machine, in particular a press drive, comprises an electric motor, a transmission and a brake. Since a flywheel is dispensed with, such a drive is also referred to as a “direct drive.” Corresponding drives for working machines equipped with a flywheel and/or driven via a belt drive are not referred to as direct drives.

In an application as a press drive, the electric motor together with the transmission is arranged on the one side of the press housing and drives a press shaft. The brake is arranged on the other side of the press housing and brakes the motor via the press frame as needed.

Such an arrangement has drawbacks. For example, an extended press shaft is necessary to be able to flange the brake in a suitable manner. A complete braking unit is also necessary, which is bothersome to mount on the press housing. Furthermore, additional wiring is to be provided for driving the brake, which must be installed to extend as far as the side of the press housing facing away from the electric motor or the transmission. Further, a protective device for the brake must be provided.

### SUMMARY OF THE INVENTION

It is accordingly an object of the invention to provide a drive for a working machine, which overcomes the above-mentioned disadvantages of the heretofore-known devices and methods of this general type and which provides for a corresponding drive that can be made cheaper than a drive known from the state of the art, with reduced wiring overhead and without an additional protective device for the brake.

With the foregoing and other objects in view there is provided, in accordance with the invention, a drive for a working machine, such as a drive for a press. The drive comprises:

an electric motor;

a transmission connected to the electric motor; and

a brake disposed between the transmission and the electric motor.

In other words, the present invention provides for the drive to include an electric motor, a transmission, and a brake that is arranged between the transmission and the electric motor. By these means it is possible for the brake to be incorporated into the drive, at least, however, it need no longer be arranged as a separate part on the side of the press housing opposite the electric motor or the transmission. By now arranging the brake near the electric motor or the transmission, wiring overhead can also be substantially reduced, in particular, electric and other supply lines need no longer be installed on both sides of the press housing. The brake housing can also be made in a substantially more material-saving manner, since, for example, a brake housing completely surrounding the brake is no longer needed. Portions of the transmission or the transmission housing and/or portions of the electric motor or the electric motor housing can also be used as a brake housing.

Further advantageous embodiments of the present invention can be derived from the features of the dependent claims.

In accordance with an added feature of the invention, the drive is equipped with a drive shaft, wherein the drive shaft is provided at least between the electric motor and the transmission, wherein the drive shaft passes through the brake and can be braked by the brake.

It is advantageous that the brake between the transmission and the electric motor can be made smaller in relation to the transmission gear ratio with respect to the torque, than in a drive known from the state of the art. This results in considerable cost savings.

In accordance with an additional feature of the invention, the drive comprises a housing, wherein the transmission, at least partially, and the brake are accommodated together in the housing. This compact structure contributes to the effect that the drive has only little weight and only occupies little structural space, whereby the suggested drive is extremely suitable to be mounted on one side of a working machine, in particular a forming press.

In accordance with another feature of the invention, the housing comprises a transmission housing and a brake housing. The transmission housing is equipped with a press housing connecting flange and a brake housing connecting flange. The brake housing is equipped with a transmission housing connecting flange and an electric motor connecting flange.

In particular, it can be advantageously provided that the transmission is a planetary transmission. A planetary transmission facilitates the necessary reduction of the rotary movement and only occupies little structural space. The entire drive can thus be made very compact and, in particular, light which is advantageous, especially, in the context of mounting the drive including the brake on only one side of the working machine, in particular the forming press. For example, little structural space is wasted adjacent the working machine, and the static weight load on the working machine is at least slightly reduced, since the drive can already be made lighter.

As an advantageous electric motor for the drive according to the present invention, a torque motor or a servo motor can be considered, which can create substantial torques while only occupying the smallest structural space.

To couple the hollow shaft of the torque motor to the drive shaft, it is preferably provided that the drive shaft is equipped with a second gear, wherein the drive shaft is equipped with an adapter, wherein the adapter is mounted on the hollow shaft, wherein the adapter, in particular, is equipped with a toothing which is in engagement with the second gear of the drive shaft. The adapter is for realizing a plug-and-socket connection between the electric motor and the drive shaft. By exchanging the adapter it is very simple to equip the drive with different electric motors. The adapter can also be formed with a clamping set. This embodiment can thus also contribute to making the drive very cheap, since a great variety of electric motors can be used.

In this context it is advantageous for the adapter to be a hollow cylinder at least embracing a section of the drive shaft.

It is a further object of the present invention to provide a working machine, in particular a forming press, comprising a press housing, a press shaft, and a drive for the press shaft, which can be made cheaply and wherein a portion of the cable material, the protective devices and the housing, which must be provided in a working machine according to the state of the art, can be economized.

With the above and other objects in view, there is also provided, in accordance with the invention, a working machine, such as a press or forming press, with a drive as outlined above. By using the drive it is possible to avoid providing a brake on the side of the press housing or the press shaft opposed to the electric motor or transmission. By these means, in the working machine according to the present invention, part of the accessories, such as a separate protective device for the brake, can be dispensed with. Part of the housing material for the brake can also be economized, since portions of the transmission housing or the electric motor can also be used as a housing for the brake. A portion of the electric and other supply lines for the brake can also be dispensed with, since the wiring or other supply lines can be directly installed to extend to the unit consisting of electric motor, brake and transmission, i.e. the drive according to the present invention.

Other features which are considered as characteristic for the invention are set forth in the appended claims.

Although the invention is illustrated and described herein as embodied in a drive for a working machine, in particular a press drive, and a working machine, in particular a forming press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a drive for a working machine, in particular a press drive according to the prior art;

FIG. 2 shows a drive according to the present invention for a working machine, in particular a press drive, in a partial sectional side view;

FIG. 2A shows a drive according to the present invention for a working machine, in particular a press drive, in a partial sectional side view (extended partial view according to FIG. 2);

FIG. 2B shows a drive according to the present invention for a working machine, in particular a press drive, in a partial sectional side view (extended partial view according to FIG. 2);

FIG. 3 shows a drive according to the present invention for a working machine, in particular a press drive, in a partial sectional perspective view;

FIG. 4 shows a drive according to the present invention for a working machine, in particular a press drive, in a partial sectional perspective view, but without electric motor; and

FIG. 5 shows a drive according to the present invention for a working machine, in particular a press drive, mounted on a press or a press housing.

### DETAILED DESCRIPTION OF THE INVENTION

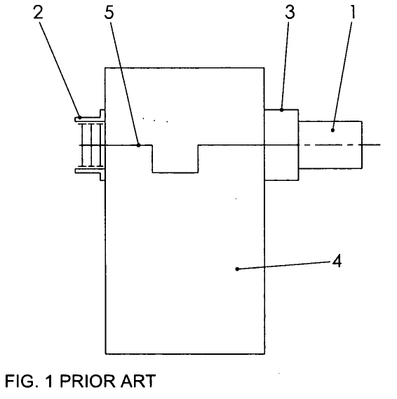

Referring now to the figures of the drawing in detail and first, particularly, to FIG. 1 thereof, there is shown a schematic view of a press or a press drive according to the prior art. The press comprises a press housing 4, on which both an electric motor 1 together with a transmission 3 and a brake 2 are mounted. The brake 2 and the electric motor 1 with the transmission 3 are arranged on opposite sides of the press housing 4. Furthermore, a press shaft 5 is arranged between the brake 2 and the transmission 3 or the electric motor 1.

This arrangement has the above-mentioned drawbacks, in particular the press shaft 5 is forced to protrude out a distance from the press housing 4 so that the brake 2 can be connected to the press shaft 5. A complete brake 2 is also necessary, that is, at least a complete brake housing is necessary, which protects the brake 2 against dirt and the like. The brake 2 is correspondingly bothersome to mount on the press housing 4. Furthermore, an additional wiring is to be provided for controlling the brake 2, which must be installed to extend up to the side of the press housing 4 facing away from the electric motor 1 or the transmission 3. Further, a protective device for the brake 2, in particular a protective device for covering the rotating parts, is to be provided.

It is suggested according the present invention that the brake 2 should now be arranged between the electric motor 1 and the transmission 3, and in particular should not be separately provided on the end of the press shaft 5, which is opposed to the electric motor 1 or the transmission 3. The brake 2 can be incorporated in the drive for a working machine. A drive according to the present invention thus comprises, as seen in the direction of the longitudinal or rotary axis 15, a transmission 3, a brake 2 and an electric motor 1 in the order mentioned above.

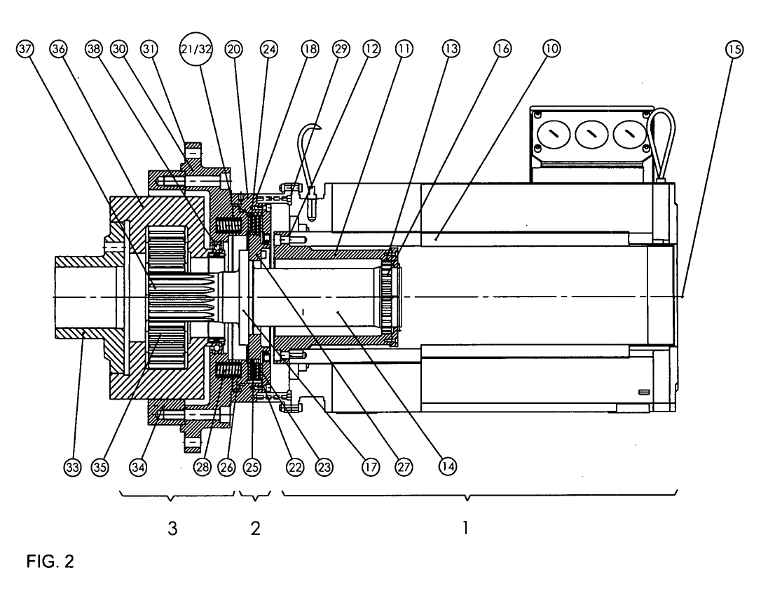

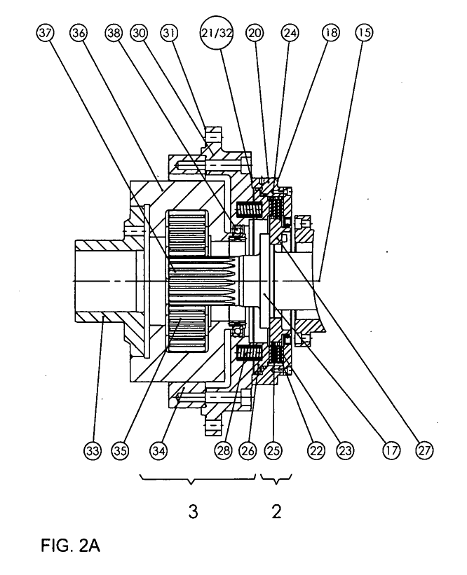

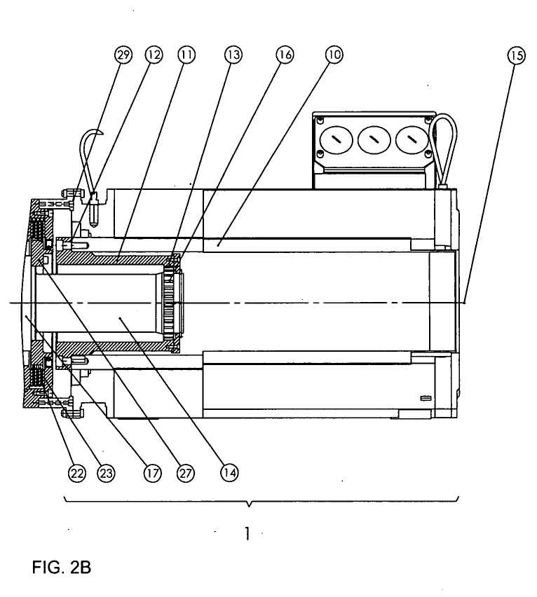

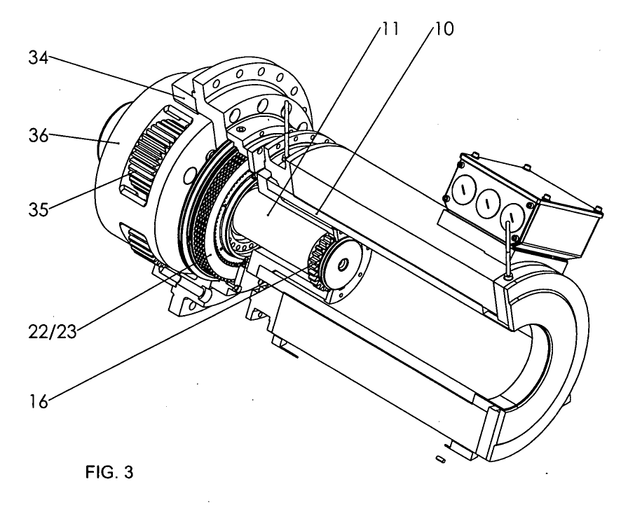

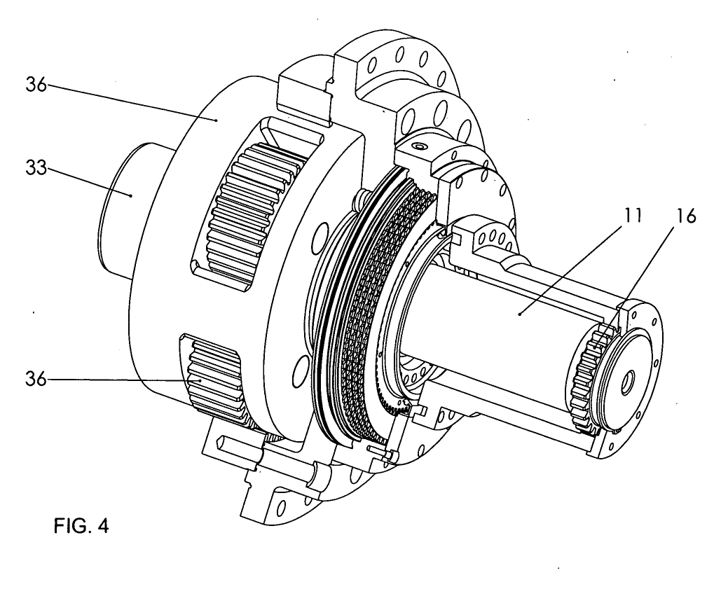

FIGS. 2 to 5 illustrate a preferred embodiment of a drive according to the present invention for a working machine, in particular a press drive. In each case, the arrangement of electric motor 1, brake 2, transmission 3, brake housing 4, or press shaft 5 can be seen.

A drive according to the present invention comprises a drive shaft 14, which extends from the electric motor 1, via the brake 2 to the transmission 3. The drive shaft 14 is rotation symmetrical and has a longitudinal axis 15 coinciding with the rotary axis of the drive shaft 14. The drive shaft 14 transmits the torque of the electric motor 1 to the transmission 3. On the one hand the drive shaft 14, on its end, has a first gear 37, and on the other hand, also on its end, a second gear 16. Furthermore, the drive shaft 14 is equipped with a brake connecting flange 17. The brake connecting flange 17 is formed as a circumferential collar with corresponding threaded bores. The connection between the drive shaft 14 and the brake 2, in particular a brake disk carrier 27, can also be configured as a clamp ring connection. The electric motor further has a brake housing connecting flange 18 for connection to a brake housing 20.

The transmission 3 comprises, essentially, a transmission housing 30 and a planetary transmission. The planetary transmission comprises a hollow gear 34, a number of planetary wheels 35 in a planet carrier 36, and a sun gear 37. The sun gear is formed by the first gear 37 of the drive shaft 14. The hollow gear 34 is connected to the transmission housing 30. The planet carrier 36 is equipped with a press shaft connecting flange 33. The transmission housing 30, in turn, comprises a press housing connecting flange 31 and a brake housing connecting flange 32. The press housing connecting flange 31 is essentially configured as a circumferential collar with a number of through bores. The brake housing connecting flange 32 essentially comprises a number of threaded bores. The planet carrier 36 is rotatably received in the transmission housing 30 via a bearing 38, in particular a ball bearing.

The brake 2 preferably comprises a brake housing 20 with a transmission housing connecting flange 21 and an electric motor connecting flange 29. The brake 2 further comprises a cylindrical brake piston 26, a number of annular first brake disks 22 or brake lamellae 22, a number of annular second brake disks 23 or brake lamellae 23, and the annular brake disk carrier 27.

The first brake disks 22 are connected to the brake housing via a connecting means. The connecting means comprises a sliding toothing 24 on the inner side wall of the brake housing 20, wherein the first brake disks 22 are equipped with a corresponding sliding toothing 24 at their circumference. With this connecting means, the first brake disks 22 are axially slidably received in the brake housing 20. It is possible, however, to transmit a torque, a braking torque in the present case, from the first brake disks 22 to the brake housing 20.

The second brake disks 23 are connected to the brake disk carrier 27 via a connecting means. The connecting means comprises a sliding toothing 25 on the outer side wall of the brake disk carrier 27, wherein the second brake disks 23 are equipped with a corresponding sliding toothing 25 on their inside. The second brake disks 23 are axially slidably received on brake disk carrier 27 by this connecting means. It is also possible, however, to transmit a torque, a braking torque in the present case from the second brake disks 23 to the brake disk carrier 27.

Pressure springs 28 are provided between the transmission housing 30 and the brake piston 26 for activating the brake 2. The pressure springs 28 are configured to press the brake disk assembly comprising the first brake disks 22 and the second brake disks 23 against one another, or against the brake housing 20 so that a braking torque is generated by friction between the brake disks 22, 23.

The electric motor 1 is preferably a servo motor with a correspondingly driven hollow shaft 10. The hollow shaft 10 is connected with the drive shaft 14 by means of an adapter 11. It is provided that the adapter 11 is a hollow cylindrical sleeve, wherein the sleeve is equipped with a hollow shaft connecting flange 12, and with a toothing 13 for connection to the second gear 16 of the drive shaft 14.

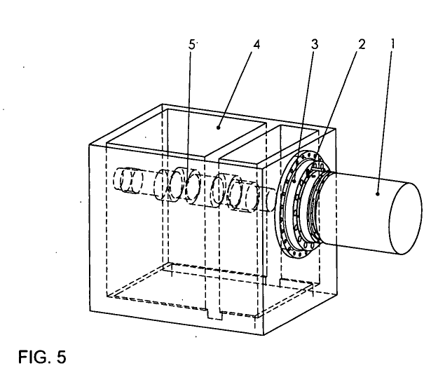

FIG. 5, finally, shows a working machine, also according to the present invention, in particular a forming press, comprising a press housing 4, a press shaft 5, and a drive 1, 2, 3. The forming press is preferably provided for forming metal. The drive is a drive according to the present invention so that the working machine according to the present invention can dispense with a separate brake, in particular with a brake mounted on the side of the housing 4 of the forming press opposed to the electric motor 1 or the transmission 3.

Further features of the drive according to the present invention can be derived from the following functional description.

The servo motor 1 rotates the adapter 11 and therefore the drive shaft 14 in a corresponding fashion. The rotary movement is transmitted into the planetary transmission via the sun gear 37, whereby a press shaft connecting flange 33 is rotated, which in turn drives the press shaft 5. The press shaft could also be immediately coupled to the planet carrier 36. The gear reduction between the drive shaft 14 and the press shaft connecting flange 33 can be adjusted by corresponding design of the transmission 3, in particular the planetary transmission.

The drive shaft 14 can be braked as needed by the brake 2 interposed between the electric motor 1 and the transmission 3. For this purpose, the pressure springs 28 are provided. With these pressure springs the brake piston 26 can be displaced so that the first brake disks and the second brake disks are pressed together. A braking torque can thus be created for decelerating the rotary movement of the drive shaft 14. To release the brake, the brake piston 26 is provided, with which the spring force of the pressure springs 28 is released by moving the brake piston.

Overall, the suggested drive is distinguished by its compact structure. This is achieved, among other things, by incorporating the brake in the transmission housing. A flywheel can also be dispensed with, which can further contribute to a compact structure. Furthermore, no coupling-brake combination is needed for the suggested drive, whereby the structural space can also be kept very small. This additionally serves to save weight.

1. A drive for a working machine, comprising:
an electric motor;
a transmission connected to said electric motor; and
a brake disposed between said transmission and said electric motor.

2. The drive according to claim 1 configured as a press drive.

3. The drive according to claim 1, which further comprises a drive shaft connected to and extending between said electric motor and said transmission, said drive shaft passing through said brake and being capable of being braked by said brake.

4. The drive according to claim 1, which further comprises a housing, and said transmission, at least partially, and said brake are accommodated together in said housing.

5. The drive according to claim 4, wherein said housing comprises a transmission housing and a brake housing, said transmission housing having a press housing connecting flange and a brake housing connecting flange, and said brake housing having a transmission housing connecting flange and an electric motor connecting flange.

6. The drive according to claim 1, wherein said transmission is a planetary transmission comprising a sun gear, a hollow gear, and a planet carrier with a plurality of planet gears.

7. The drive according to claim 6, wherein said transmission is housed in a transmission housing and said hollow gear is connected to said transmission housing.

8. The drive according to claim 6, wherein said drive shaft is equipped with a first gear, and said first gear forms said sun gear of said planetary transmission.

9. The drive according to claim 1, wherein the electric motor is a servo motor with a driven hollow shaft.

10. The drive according to claim 9, wherein said drive shaft is equipped with first gear, a second gear, and an adapter, said adapter is mounted on said hollow shaft, and said adapter is equipped with a toothing disposed to mesh with said second gear of said drive shaft.

11. The drive according to claim 1, wherein said adapter is a hollow cylinder embracing at least a section of said drive shaft.

12. The drive according to claim 1, wherein said drive shaft has a brake connecting flange.

13. The drive according to claim 1, wherein said brake comprises a brake disk assembly with at least one first brake disk and at least one second brake disk mounted to be brought into contact with one another to generate a braking force.

14. The drive according to claim 13, wherein said brake further comprises:
a brake housing and first connecting means for connecting said at least one first brake disk with said brake housing, said first connecting means comprising a sliding toothing on an interior side wall of said brake housing and a corresponding sliding toothing on a circumference of said at least one first brake disk;
a brake disk carrier with an exterior side wall and second connecting means for connecting said at least one second brake disk with said brake disk carrier, said second connecting means comprising a sliding toothing on said exterior side wall of said brake disk carrier and a corresponding sliding toothing on an inside of said at least one second brake disk; and
a brake piston configured to be pressed via pressure springs onto said brake disk assembly for generating a braking force.

15. The drive according to claim 14, wherein said brake piston is a cylindrical brake piston.

16. The drive according to claim 1, wherein said electric motor, said brake, and said transmission are arranged along a common longitudinal axis.

17. A working machine, comprising:
a machine housing;
a machine shaft; and
a drive according to claim 1 operatively connected to and driving said machine shaft.

18. The working machine according to claim 17 configured as a forming press with said machine housing in the form of a press housing, said machine shaft in the form of a press shaft, and said drive in the form of a press drive.
